(19) United States
(12) Patent Application Publication
(10) Pub. No.: US 2021/0313593 A1
(43) Pub. Date: Oct. 7, 2021

(54) SEPARATOR PLATE COMPRISING A POSITIONING OPENING AND METHOD

(71) Applicant: Reinz-Dichtungs-GmbH, Neu-Ulm (DE)

(72) Inventors: Rainer GLUECK, Dornstadt (DE); Bernd RUESS, Voehringen (DE)

(21) Appl. No.: 17/221,712

(22) Filed: Apr. 2, 2021

(30) Foreign Application Priority Data
Apr. 3, 2020 (DE) 10 2020 204 405.8

(51) Int. Cl. H01M 8/0258; H01M 8/0267; H01M 8/0247

(52) U.S. Cl. CPC H01M 8/0258; H01M 8/0247; H01M 8/0267

(57) ABSTRACT

The present disclosure relates to a separator plate for an electrochemical system, comprising: a flow field for conducting a medium along a planar face of the separator plate; at least one positioning opening; and one projection and one collar per positioning opening, wherein the projection and the collar wrap around the positioning opening and wherein the collar adjoins the positioning opening and the projection. The present disclosure further relates to a bipolar plate and to production methods for the separator plate and the bipolar plate.

### CROSS-REFERENCE TO RELATED APPLICATION

The present application claims priority to German Patent Application No. 10 2020 204 405.8, entitled “SEPARATOR PLATE COMPRISING A POSITIONING OPENING AND METHOD FOR THE PRODUCTION THEREOF,” and filed on Apr. 3, 2020. The entire contents of the above-listed application are hereby incorporated by reference for all purposes.

### TECHNICAL FIELD

The present disclosure relates to a separator plate for an electrochemical system and to a method for the production thereof, the separator plate having at least one positioning opening. The electrochemical system can in particular be a fuel cell system, an electrochemical compressor, an electrolyzer, or a redox flow battery. The present disclosure also relates to bipolar plates composed of separator plates of that kind.

### BACKGROUND AND SUMMARY

Known electrochemical systems usually comprise a stack of electrochemical cells, each separated by metal separator plates. Often, two of these separator plates together form a bipolar plate. These bipolar plates usually comprise two metal separator plates, i.e. individual plates, that are joined together, typically welded together, and which are normally manufactured from thin metal sheets. Each bipolar plate thus then contains a first metal sheet as a first separator plate and a second metal sheet as a second separator plate. The bipolar plates, or the separator plates forming the bipolar plates, can, for example, be used for electrically contacting the electrodes of the individual electrochemical cells (e.g. fuel cells, in particular indirectly) and/or for electrically connecting adjacent cells (series connection of cells).

The bipolar plates, or the separator plates or individual plates forming the bipolar plates, can have a channel structure, which is configured to supply the cells with one or more media and/or to carry reaction products away. The media can, for example, be fuels (e.g. hydrogen or methanol), reaction gases (e.g. air or oxygen) or coolants. A channel structure of this kind is usually arranged in an electrochemically active region (gas distributor structure/flow field). Furthermore, the bipolar plates, or the separator plates or individual plates forming the bipolar plates, can be configured to transfer the waste heat produced when electrical or chemical energy is converted in the electrochemical cell and to seal the various media channels or cooling channels from one another and/or with respect to the exterior. Said channel structures and/or sealing structures, in particular sealing beads, are, for example, stamped into the separator plates or individual plates by means of a stamping die. Similar structures are also present in separator plates of humidifiers for electrochemical systems. Therefore, the statements below can also apply accordingly to separator plates for humidifiers.

Generally, the bipolar plates have a number of tasks: electrically contacting, in particular indirectly electrically contacting, the electrodes of the individual electrochemical cells and transferring the current to the adjacent cell (series connection of cells); supplying the cells with reactants, e.g. hydrogen or oxygen/air, and e.g. carrying the generated reaction gas away by means of a corresponding distributor structure; transferring the waste heat produced during the generation in the electrochemical cell, i.e. feeding in and removing the coolant; and sealing the various media channels or cooling channels of the “flow field” from one another and with respect to the outside.

When producing the separator plates or bipolar plates, it is highly important to adhere to narrow size tolerances, otherwise functional or even safety-critical malfunctions may occur. This is particularly essential for multi-layer bipolar plates if they are welded tight at the outer edge, but in particular also if they have welds in the region of the flow field for reducing the transfer resistance.

In the steps required to produce a bipolar plate from two separator plates, however, a multiplicity of inaccuracies may occur. Typically, when each of the individual plates of a bipolar plate is worked, at least two different dies are usually used, e.g. a stamping die for deforming regions of the individual plate and a punching die for making through-openings in the individual plate. If the individual plate is not optimally positioned in at least one of the dies, a relative orientation of the stamped structures of said individual plate with respect to the punched structures of the same individual plate may consequently diverge from an ideal relative orientation. Alternatively or additionally, when a first individual plate or a first metal sheet is joined to a second individual plate or a second metal sheet, assembly errors may occur if a relative orientation, in the joining die, of the two individual plates or metal sheets to be joined diverges from an ideal relative orientation in the joining die.

Up to now, positioning holes were used to ensure the bipolar plates were precisely positioned with respect to one another. When these positioning holes, which ensure that the at least two separator plates are precisely positioned with respect to one another, are made at the same time as the other through-openings and at the same time that the outer edges of the separator plates are trimmed, it has been found in practice that the precision and reproducibility of the positioning of the separator plates with respect to one another is inadequate. In that case, the channel geometries of the separator plates are misaligned in particular. If there is an extreme misalignment between the channels, then when the separator plates of the bipolar plate are connected, welding is performed at sites at which the separator plates are not resting on top of one another, and so thermal damage may occur, potentially as early as during the welding of the electrochemical system. In addition, when the stack is constructed, imprecision of the positioning of a bipolar plate, which is formed from two separator plates, may occur with respect to the next bipolar plate or further on to other bipolar plates, such that there is misalignment between the channel structures within the electrochemical cell constructed in this manner, and thus loss of performance or damage to the components may occur; in particular, thermal damage may also occur during operation.

Another approach is to position the separator plates relative to one another by means of their outer contour. In this approach, however, the plates may not always be arranged with the required precision with respect to one another; in particular, it does not allow for positioning with respect to the molded-in structures, e.g. channel structures.

Therefore, an object of the present disclosure is to provide a separator plate and a method for producing a separator plate by which at least some of the aforementioned problems can be overcome.

This object may be achieved by the subject matter of the independent claims. The following description and the dependent claims describe developments and advantageous embodiments.

According to one aspect of the present disclosure, a separator plate for an electrochemical system is provided. The separator plate comprises: a flow field for conducting a medium along a planar face of the separator plate; at least one positioning opening; and one projection and one collar per positioning opening, the projection and the collar wrapping around the positioning opening, and the collar adjoining the positioning opening and the projection.

In particular, the function of the positioning opening is merely to position the separator plate, e.g. relative to a die, to a further, directly adjoining separator plate or to a further, indirectly adjoining separator plate. The die in which the separator plate can be positioned in a defined manner by means of the positioning opening can, for example, be a positioning device, a fixing device, a joining die, a surface-treatment device such as a coating device and/or a surface-structuring device, or a cutting device, in particular a punching or laser-cutting device. In general, the at least one positioning opening allows for the insertion of a centering pin of said die. Said die therefore normally comprises at least one centering pin which can be received in the positioning opening e.g. by means of a form fit.

The positioning opening is generally formed as a through-opening. Normally, however, this kind of through-opening is not associated with any media-conducting function. In particular, the positioning opening differs from any fluid-conveying through-openings which may be formed in the separator plate and which, for example, form channels for the inflow or outflow of fluids.

The projection and the collar typically form a stamped structure. As a result, the final formation of the positioning opening can be carried out in a single die, namely a stamping device, and in just one operation (see also the production method described below). The precision of the production of the positioning opening thus depends on a single die, as a result of which production tolerances can be adhered to considerably more effectively. In particular, the final formation of the positioning opening can be carried out in the same die as used for forming other stamped structures, and so production tolerances remain constant in one die once completed.

The projection can comprise or be formed by a circumferential bead, for example a half-bead. Normally, however, this kind of bead is not associated with any sealing function. The separator plate typically defines a plate plane. In the process, this plate plane is generally oriented perpendicularly to a stacking direction of the separator plate. The projection typically comprises a circumferential flank portion and a circumferential plateau portion, the plateau portion adjoining the collar. In the region of the flank portion, the plate material rises obliquely out of the plate plane. The plateau portion is a region that extends substantially in parallel with the plate plane.

As a result of the collar that adjoins the positioning opening, an exposed sharp edge of the positioning opening, as is often the case in the prior art, can be avoided. The risk of injury during installation, stacking or transportation of the separator plate can consequently be considerably reduced. The collar can be oriented at an angle, in particular substantially perpendicularly, to the plate plane. In this respect, the term “substantially perpendicularly” means that divergences of up to 10°, preferably up to 5°, in particular up to 3°, relative to a 90° angle are permitted. Typically, the collar protrudes through the plate plane. In addition, between the plateau portion and the collar, the separator plate can have a curvature region facing the plate plane.

The collar and/or the positioning opening can define an axial direction. In some configurations, an axial length of the collar is not constant in the circumferential direction of the collar. In other words, a free end of the collar spanning a slanted plane can thus be formed. In the process, the slanted plane is oriented at an angle to the plate plane, in particular not in parallel with the plate plane. The slanted plane can in particular be caused by the positioning opening and the collar being formed by stamping a pre-punched position hole and by the arrangement of the position hole having a certain production tolerance (see also the production method below). In some embodiments, an axial length of the projection is approximately constant in the circumferential direction of the projection. Said axial length (of the collar or projection) can also be referred to as the height, with the height (or the axial length) being determined perpendicularly to the plate plane, in particular to the neutral axis of the separator plate or to one of the surfaces thereof.

The separator plate can have further stamped structures. These further stamped structures can have structures for conducting media along the separator plate, such as the flow field, and/or at least one self-contained sealing element, for example a sealing bead. In this case, the self-contained sealing element is configured firstly to seal the various media conducted in the stack from one another, which stack is formed by a plurality of separator plates, and secondly to seal the corresponding media from the surroundings of the stack. The at least one self-contained sealing element can, for example, have a perimeter bead that wraps around the flow field and seals said flow field from the surroundings of the separator plate. Additionally or alternatively, the at least one self-contained sealing element can have a port bead that seals a through-opening for media.

Said sealing element can be a raised portion in the form of a sealing bead, in particular a full bead, that is formed, in particular stamped, in the separator plate. In some embodiments, the sealing element has a self-contained recess and an elastomeric sealing lip, the sealing lip being able, for example, to be either placed in the recess, or molded-on in the recess (e.g., by being formed from a different material, either in the same process used to form the separator plate, or in a separate, subsequent process, such as a stamping process or molding process or application process). In this case, the depth of the recess can be significantly smaller than the extension of the elastomeric sealing lip in the same direction.

The positioning opening can be arranged outside the self-contained sealing element, in particular outside the self-contained sealing bead or the self-contained recess of the sealing element and/or the further stamped structures. Typically, the positioning opening is spaced apart from the self-contained sealing element and the further stamped structures.

A maximum height of the projection and/or a maximum height of the collar of the positioning opening can be smaller than either a maximum height of the further stamped structures or an average height of the further stamped structures. The maximum height of the projection and/or of the collar can also be smaller than either a maximum height or an average height of the self-contained sealing element, i.e. of the sealing bead or the combination of the recess and sealing lip. In this case, the recess generally makes up only a small proportion of the total height of the sealing lip plus the recess. In particular, the maximum height of the projection and/or of the collar can be smaller than either a maximum height or an average height of a sealing bead stamped into the separator plate, and in particular also when the sealing bead of the separator plate is in the properly compressed state, such that the projection and/or the collar itself/themselves is/are not compressed.

For a maximum diameter dₘₐₓ of the positioning opening, it may be that it is smaller than a maximum diameter of a smallest media-conducting through-opening of the separator plate, the smallest media-conducting through-opening being oriented in parallel with the plate plane. Said smallest media-conducting through-opening should not be confused with passages formed in the sealing beads, since openings of these passages are oriented not in parallel with the plate plane but rather substantially perpendicularly to the plate plane (cf. passages 13a-13c in the accompanying FIG. 2).

The positioning opening, the collar and/or the projection can be symmetrical, for example rotationally symmetrical (e.g. discretely or continuously) or in mirror symmetry with respect to a mirror plane perpendicular to the plate plane. In particular, the positioning opening can be formed to be circular, oval, slot-shaped or polygonal having rounded corners. A distance, measured in the radial direction, from a center point, e.g. the center of gravity, of the positioning opening to the collar can be either constant or not constant.

As indicated above, production tolerances of the positioning opening of the separator plate can be adhered to significantly more effectively. For instance, the positioning opening and the flow field can be at a predetermined position and/or orientation with respect to one another. Preferably, a divergence from the predetermined position is less than 200 μm, preferably less than 100 μm, in particular less than 50 μm.

The separator plate is preferably made of metal, preferably of steel, in particular stainless steel. Metal sheets are particularly suitable for producing the separator plate.

The positioning opening, the collar and/or the projection are preferably formed integrally, i.e. in one piece, with the separator plate, i.e. in particular in or out of the metal sheet of the separator plate (e.g., by being formed as part of the separator plate, and not as separate elements connected, fastened, or otherwise secured to the separator plate). This means that the collar and/or the projection is/are molded-in directly into the separator plate, in particular into the metal sheet thereof. The positioning opening is preferably likewise molded-in directly into the separator plate, in particular into the metal sheet thereof. Unlike with a positioning opening that effectively is a molded-on elastomer, which reduces the size of an opening formed in the plate material, or with an element that is secured in a floating manner in a in the plate material and forms the effective positioning opening, in this way the relative position of the positioning opening of the separator plate relative to the other stamped structures, in particular to those of the flow field, can be defined and adhered to as precisely as possible.

According to a further aspect of the present disclosure, a bipolar plate is proposed. The bipolar plate comprises a first separator plate according to the above embodiments and a second separator plate according to the above embodiments. The first separator plate has a first positioning opening having a first projection and a first collar. Furthermore, the second separator plate has a second positioning opening having a second projection and a second collar. The first positioning opening is smaller than the second positioning opening. In the bipolar plate, the first collar engages in the second collar, the two separator plates thus being joined together with precise positioning.

The first positioning opening and the second positioning opening of the two separator plates are arranged in alignment and can together form a positioning opening of the bipolar plate; in other words, the positioning opening of the bipolar plate is formed by the collar having the smaller diameter or area. The collar having the larger diameter or area is then spaced apart from the common positioning opening by the collar having the smaller diameter or area.

In some embodiments, the first collar and the second collar mesh with one another in a form-fitting manner, or in a form-fitting manner at least in some portions, or in a form-fitting manner only in some portions. In particular, the two collars form a circumferential form fit or a partly circumferential form fit. When the plates are joined, therefore, one collar is preferably inserted into the other collar. The two collars can contact one another at least in some regions.

According to some embodiments, the collars and the positioning openings define an axial direction, the second collar having a shorter axial length than the first collar. Often, end portions of the two collars point in opposite directions. In this case, the two projections of the separator plates can face away from one another. As a result, the projections can form a cavity. Alternatively, however, the end portions of the two collars can also point in the same direction. In this case, the projections of the two separator plates can contact one another at least in some regions.

A maximum height of the positioning opening of the bipolar plate and/or a maximum height of the first collar can be smaller than a maximum height of the sum of stamped structures, that face away from one another (e.g. sealing element and/or media-carrying channel structures), of the two separator plates forming the bipolar plate. As above, in this case the height is measured perpendicularly to the plate plane. This also applies to the above-mentioned compressed state of the beads, i.e. unlike the beads the collars and/or projections of the positioning opening of the bipolar plate are normally not compressed therewith.

According to a further aspect of the present disclosure, an electrochemical system is provided which has a multiplicity of stacked separator plates or bipolar plates of the above-described type.

According to a further aspect of the present disclosure, a method for producing a separator plate, preferably the separator plate according to the above-described embodiments, is proposed. The method comprises at least the following steps: providing a plate, forming, in particular punching, at least one position hole in the plate, deforming the plate such that, simultaneously, one positioning opening having one projection and one collar is formed per position hole, and a flow field is formed for conducting a medium along a planar face of the separator plate, the projection and the collar wrapping around or surrounding the positioning opening, the collar adjoining the positioning opening and the projection.

Unlike in the prior art, the positioning opening is thus formed at the same time as the flow field. The result of this is that the relative arrangement of the positioning opening with respect to the flow field is mainly determined by the deformation step. This allows for a very precise arrangement of the positioning opening relative to the flow field, as a result of which tolerances can be adhered to more effectively. The final arrangement of the center point of the positioning opening can thus differ from the initial arrangement of the center point of the position hole, said initial arrangement being produced, for example, when the position hole is punched or cut.

In this case, the tolerances can be adhered to or minimized in two ways. Firstly, a divergence with respect to the desired distances can be reduced to a minimum by the positioning opening and the flow field being molded-in at the same time, and also by a good advance calculation of the deformation operations. Secondly, with the same die being used for molding-in various plates, the simultaneous molding-in of the positioning opening and the flow field into the same plate leads to negligible divergences between the various plates.

According to a variant, the collar is formed by deforming an edge of the position hole. In some embodiments, the deformation of the plate involves deep-drawing, stamping and/or hydroforming the plate.

By means of the method, therefore, the above-described separator plate in particular can be produced. Features of the above-described separator plate can thus be combined with the production method, and vice versa.

According to a further aspect of the present disclosure, a method for producing a bipolar plate, preferably of the above-described type, is provided. The bipolar plate has a first separator plate and a second separator plate. The method has at least the following steps: producing the first separator plate having at least a first collar and a first positioning opening, preferably in accordance with the above method, and producing the second separator plate having at least a second collar and a second positioning opening, preferably in accordance with the above method.

In this case, the first positioning opening is smaller than the second positioning opening. In addition, the method for producing the bipolar plate comprises the following steps: positioning the separator plates on top of one another such that the first collar engages in the second collar, and joining the two separator plates.

The separator plates are in particular positioned relative to one another by means of a positioning device or a joining device. For this purpose, the positioning device can have at least one centering pin, which is typically configured to engage in the first positioning opening and/or the second positioning opening.

The two positioning openings of the separator plates can form a first positioning opening of the bipolar plate. The bipolar plate can also have a plurality of positioning openings, each formed by two positioning openings of two separator plates.

If the bipolar plate has two positioning openings, two corresponding positioning devices per separator plate pair or bipolar plate can normally be used to produce the bipolar plate. For the first positioning opening, a circumferential form fit of the two separator plates can be provided, whereas the form fit may be only present in some portions for the second positioning opening. As a result, a residual mobility of the separator plates relative to one another may be present before the final fixing in place (e.g. welding).

The separator plates are form-fittingly fixed in place, preferably at least in some portions, by the first collar engaging in the second collar.

In the connection step, the separator plates can be interconnected, preferably integrally bonded, in particular by means of welding or soldering, in particular laser beam welding, or gluing.

By means of the method, therefore, the above-described bipolar plate in particular can be produced. Features of the above-described bipolar plate can thus be combined with the production method, and vice versa.

### BRIEF DESCRIPTION OF THE FIGURES

Example embodiments of the separator plate, of the bipolar plate, of the electrochemical system and of the production methods are shown in the drawings and explained in more detail on the basis of the following description. In the drawings:

FIG. 1 is a schematic perspective view of an electrochemical system comprising a multiplicity of separator plates or bipolar plates arranged in a stack;

FIG. 2 is a schematic perspective view of two bipolar plates of the system according to FIG. 1 comprising a membrane electrode unit (MEA) arranged between the bipolar plates;

FIG. 3A is a schematic section through a plate stack of a system of the type of system according to FIG. 1, with a misalignment between adjacent bipolar plates;

FIG. 3B is a schematic section through a plate stack of a system of the type of system according to FIG. 1, with a misalignment between adjacent separator plates;

FIG. 3C is a schematic section through a plate stack of a system of the type of system according to FIG. 1, in which both adjacent bipolar plates and adjacent separator plates are positioned relative to one another in a defined manner and substantially without any misalignment;

FIG. 4 is a schematic plan view of a separator plate of a bipolar plate having two positioning openings according to an embodiment of the present disclosure;

FIG. 5 is a schematic perspective view of a portion of a positioning opening according to an embodiment of the present disclosure;

FIG. 6 is a schematic perspective view of a portion of a positioning opening according to an embodiment of the present disclosure;

FIG. 7 is a schematic detailed view of a section through the positioning opening of FIG. 5;

FIG. 8 is a schematic detailed view of a section through a further positioning opening;

FIG. 9 is a schematic perspective view of a portion of a positioning opening according to a further embodiment of the present disclosure;

FIG. 10 is a schematic detailed view of a section through the positioning opening of FIG. 9;

FIG. 11 is a schematic plan view of one of the positioning openings of FIG. 4;

FIG. 12 is a schematic plan view of a further positioning opening; and

FIG. 13 is a flow chart of a method according to the present disclosure for producing a bipolar plate arrangement.

Here and in the following, features recurring in various figures are in each case denoted by the same or similar reference signs.

### DETAILED DESCRIPTION

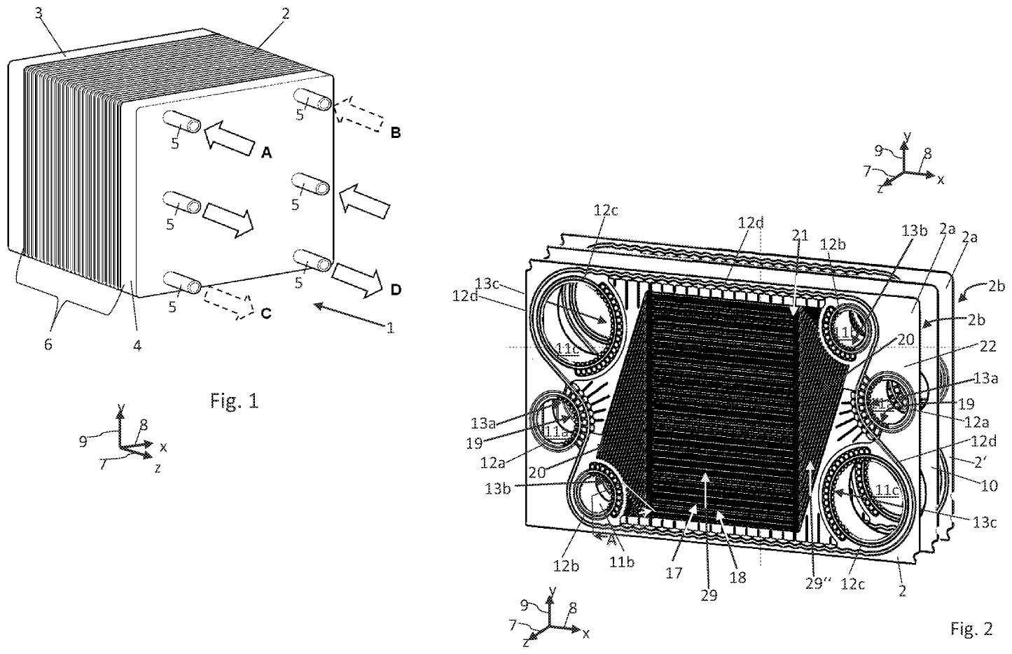

FIG. 1 shows an electrochemical system 1 having a plurality of identical metal bipolar plates 2, which are arranged in a stack 6 and stacked in a z-axis or z-direction 7. The bipolar plates 2 of the stack 6 are clamped between two end plates 3, 4. The z-direction 7 is also referred to as the stacking direction. In this example, the system 1 is a fuel cell stack. Each two adjacent bipolar plates 2 of the stack thus enclose between them an electrochemical cell, which is used, for example, to convert chemical energy into electrical energy. To form the electrochemical cells of the system 1, a membrane electrode unit (MEA) is arranged between each adjacent bipolar plate 2 of the stack (see e.g. FIG. 2). The MEAs typically each contain at least one membrane, e.g. an electrolyte membrane. Furthermore, a gas diffusion layer (GDL) may be arranged on one or both surfaces of the MEA.

In alternative embodiments, the system 1 can also be formed as an electrolyzer, an electrochemical compressor or a redox flow battery. Bipolar plates can also be used in these electrochemical systems. The construction of those bipolar plates can thus correspond to the bipolar plates 2 explained in more detail here, even though the media conducted on or through the bipolar plates in an electrolyzer, an electrochemical compressor or a redox flow battery can in each case differ from the media used for a fuel cell system. The same applies to the bipolar plates, in particular of a humidifier.

The z-axis 7 spans a right-handed Cartesian coordinate system together with an x-axis 8 and a y-axis 9. The bipolar plates 2 each define a plate plane, the plate planes of the separator plates that form the bipolar plate 2 each being oriented in parallel with the x-y plane and thus perpendicularly to the stacking direction or the z-axis 7. The end plate 4 has a multiplicity of media ports 5, via which media can be supplied to the system 1 and via which media can be carried out of the system 1. These media that can be supplied to the system 1 and carried out of the system 1 can, for example, include fuels such as molecular hydrogen or methanol, reaction gases such as air or oxygen, reaction products such as water vapor or depleted fuels, or coolants such as water and/or glycol.

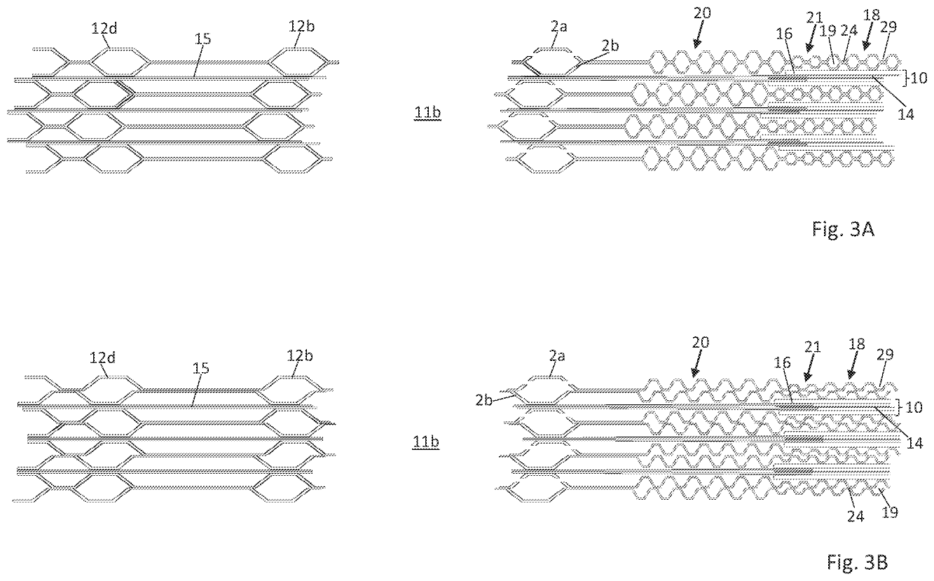

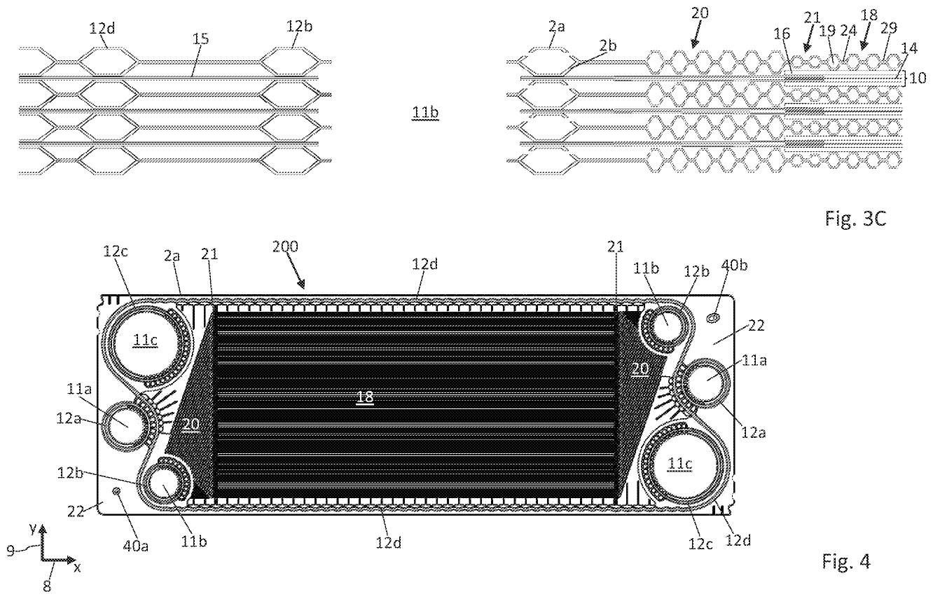

FIG. 2 is a perspective view of two adjacent bipolar plates 2 of an electrochemical system of the type of system 1 from FIG. 1, and of a membrane electrode unit (MEA) 10 known from the prior art arranged between said adjacent bipolar plates 2, the MEA 10 in FIG. 2 being largely obscured by the bipolar plate 2 facing the viewer. The bipolar plate 2 is formed from two form-fittingly joined separator plates 2a, 2b (see e.g. FIG. 3A-3C), of which only the first separator plate 2a facing the viewer is visible in FIG. 2, said first separator plate obscuring the second separator plate 2b. The separator plates 2a, 2b can each be manufactured from a metal sheet, e.g. from a stainless steel sheet. The separator plates 2a, 2b can, for example, be welded together, e.g. by laser welds.

The separator plates 2a, 2b have aligned through-openings, which form through-openings 11a-c of the bipolar plate 2. When a plurality of bipolar plates of the type of bipolar plate 2 are stacked, the through-openings 11a-c form conduits, which extend through the stack 6 in the stacking direction, e.g., z-direction 7 (see FIG. 1). Typically, each of the conduits formed by the through-openings 11a-c is in fluid communication with one of the ports 5 in the end plate 4 of the system 1. Via the conduits formed by the through-openings 11a, coolants, for example, can be conveyed into the stack or conveyed out of the stack. The conduits formed by the through-openings 11b, 11c, however, can be configured to supply the electrochemical cells of the fuel cell stack 6 of the system 1 with fuel and reaction gas, and to convey the reaction products out of the stack. The media-conducting through-openings 11a-11c are oriented substantially in parallel with the plate plane.

To seal the through-openings 11a-c from the interior of the stack 6 and from the surroundings, the first separator plates 2a each have sealing arrangements in the form of sealing beads 12a-c, which are arranged, respectively, around the through-openings 11a-c and which fully enclose the through-openings 11a-c, respectively. On the back of the bipolar plates 2 facing away from the viewer of FIG. 2, the second separator plates 2b have corresponding sealing beads for sealing the through-openings 11a-c (not shown).

In an electrochemically active region 18, the first separator plates 2a have, on their front facing the viewer of FIG. 2, a flow field 17 having structures for conducting a reaction medium along the front of the separator plate 2a. In FIG. 2, these structures are provided by a multiplicity of ridges and by channels that extend between the ridges and are delimited by the ridges. On the front, facing the viewer of FIG. 2, of the bipolar plates 2, the first separator plates 2a each also have a distribution or collection region 20. The distribution or collection region 20 comprises structures that are configured to distribute, over the active region 18, a medium that has been conveyed into the distribution or collection region 20 from a first of the two through-openings 11b and/or to collect or pool a medium flowing from the active region 18 to the second of the through-openings 11b. The distribution structures of the distribution or collection area 20 in FIG. 2 are likewise provided by webs, and channels extending between the webs and delimited by the webs. At each transition between the distribution and collection region 20 and the flow field 17 of the active region 18, a transition region 21 is located on either side of the flow field 17, in each case oriented in parallel with the y-axis or y-direction 9 in FIG. 2. In the transition region 21, the media-conveying structures can each have, for example, a smaller height compared with the adjoining regions 18 and 20. In general, the elements 17, 18, 20, 21 can thus be understood as media-conveying stamped structures.

The sealing beads 12a-12c have passages 13a-13c, which in this case are configured as local protrusions of the bead and of which the passages 13a are formed on both the underside of the upper separator plate 2a and the top of the lower separator plate 2b, whereas the passages 13b are formed in the upper separator plate 2a and the passages 13c are formed in the lower separator plate 2b. By way of example, the passages 13a allow coolant to pass between the through-opening 11a and the distribution region such that the coolant arrives in the distribution region between the separator plates and is conducted out of it. In addition, the passages 13b allow hydrogen to pass between the through-opening 11b and the distribution region on the top of the upper separator plate 2a; said passages 13b are typified by perforations that face the distribution region and extend obliquely to the plate plane. Therefore, for example hydrogen flows through the passages 13b from the through-opening 11c to the distribution region on the top of the upper separator plate 2a or in the opposite direction. The passages 13c allow for example air to pass between the through-opening 11c and the distribution region, such that air arrives in the distribution region on the underside of the lower separator plate 2b and is conducted out of it. The associated perforations are not visible here.

The first separator plates 2a each further have an additional sealing arrangement in the form of a perimeter bead 12d, which wraps around the flow field 17 of the active region 18, the distribution or collection region 20 and the through-openings 11b, 11c, and seals these from the through-opening 11a, i.e. from the coolant circuit, and from the surroundings of the system 1. The second separator plates 2b each comprise corresponding perimeter beads. The structures of the active region 18, the distribution structures of the distribution or collection region 20 and the sealing beads 12a-d are each formed in one piece with the separator plates 2a and molded into the separator plates 2a, e.g. in a stamping, deep-drawing or hydroforming process. The same applies to the corresponding distribution structures and sealing beads of the second separator plates 2b. Outside the region surrounded by the perimeter bead 12d, a predominantly unstructured outer-edge region 22 is produced in each separator plate 2a, 2b.

The two through-openings 11b or the conduits through the plate stack of the system 1, which are formed by the through-openings 11b, are each in fluid communication with one another via passages 13b in the sealing beads 12b, via the distribution structures of the distribution or collection region 20 and via the flow field 17 in the active region 18 of the first separator plates 2a facing the viewer of FIG. 2. Similarly, the two through-openings 11c or the conduits through the plate stack of the system 1, which are formed by the through-openings 11c, are each in fluid communication with one another via corresponding bead passages, via corresponding distribution structures and via a corresponding flow field on an outside of the second separator plates 2b facing away from the viewer of FIG. 2. The through-openings 11a, by contrast, or the conduits through the plate stack of the system 1, which are formed by the through-openings 11a, are each in fluid communication with one another via a cavity 19 encased or enclosed by the separator plates 2a, 2b. The cavity 19 is used in each case to conduct a coolant through the bipolar plate 2, in particular for cooling the electrochemically active region 18 of the bipolar plate 2.

FIGS. 3A, 3B and 3C are schematic sections through a portion of the plate stack 6 of the system 1 from FIG. 1, the sectional plane being oriented in the z-direction and thus perpendicularly to the plate planes of the bipolar plates 2; it can, for example, extend along the bent section A-A in FIG. 2.

The identical bipolar plates 2 of the stack each comprise the above-described first metal separator plate 2a and the above-described second metal separator plate 2b. Structures for conveying media along the outer surfaces of the bipolar plates 2 can be seen, in this case in particular each in the form of ridges and channels delimited by the ridges. In particular, channels 29 on the surfaces, facing away from one another, of adjoining separator plates 2a, 2b are shown, as well as cooling channels 19 between adjoining separator plates 2a, 2b. Between the cooling channels 19, the two separator plates 2a, 2b are located on top of one another in a contact region 24, where they are interconnected, in this example by means of laser seam welding.

Between each adjacent bipolar plate 2 of the stack, a membrane electrode unit (MEA) 10, for example known from the prior art, is arranged. The MEA 10 typically comprises a membrane, e.g. an electrolyte membrane, and an edge portion 15 connected to the membrane. By way of example, the edge portion can be integrally bonded to the membrane, e.g. by means of an adhesive connection or by lamination.

The membrane of each MEA 10 extends at least over the active region 18 of the adjoining bipolar plates 2, where it enables proton transfer via or through the membrane. In addition, the membrane reaches at least partly into the transition region 21, but not into the distribution or collection region 20. The edge portion 15 of each MEA 10 is used for positioning, securing and sealing the membrane between the adjoining bipolar plates 2. If the bipolar plates 2 of the system 1 are clamped between the end plates 3, 4 in the stacking direction (see FIG. 1), the edge portion 15 of each MEA 10 can, for example, be compressed between the sealing beads 12a-d of each adjoining bipolar plate 2 and/or at least between each perimeter bead 12d of the adjoining bipolar plates 2, in order thus to fix the membrane 14 in place between the adjoining bipolar plates 2.

Each edge portion 15 covers the distribution or collection region 20 of the adjoining bipolar plates 2. Additionally, the edge portion 15 can also either fully or at least partly cover the transition region 21 of the adjoining bipolar plates 2, or reach fully or at least partly into the transition region 21 of the adjoining bipolar plates 2 (cf. FIG. 2). Outwardly, the edge portion 15 can also reach out beyond the perimeter bead 12d, where it can adjoin the outer-edge region 22 of the separator plates 2a, 2b (cf. FIG. 2).

Furthermore, gas diffusion layers 16 can additionally be arranged in the active region 18. The gas diffusion layers 16 enable a flow against the membrane over as large a region of the membrane surface as possible, and can thus improve the proton transfer via the membrane. The gas diffusion layers 16 can, for example be arranged on either side of the membrane in the active region 18 between the adjoining separator plates 2a, 2b. The gas diffusion layers 16 can, for example, be formed from a non-woven fabric or comprise a non-woven fabric.

In principle, FIGS. 3A, 3B and 3C show sections through the same portion of the plate stack. The differences between FIGS. 3A, 3B and 3C are that the arrangement of FIG. 3A shows a misalignment between adjacent stacked bipolar plates 2, whereas the arrangement of FIG. 3B has a misalignment between adjacent separator plates 2a, 2b. The arrangements of FIGS. 3A and 3B are the result of a lack of positional accuracy when stacking the bipolar plates (FIG. 3A) or when positioning the anode plate relative to the cathode plate (FIG. 3B), as can often be observed in the prior art. The imprecise positioning of the plates 2, 2a, 2b relative to one another can have various causes. In general, when each of the separator plates 2a, 2b is worked, two different dies are used, namely a stamping die for stamping the flow field 17 and a punching die for making the through-openings 11a-c. If the separator plate is not correctly positioned in either of the two dies, this can have a negative impact on the precision in subsequent working steps. Even if the separator plates 2a, 2b have been produced with sufficient precision, the separator plates 2a, 2b can be misaligned with respect to one another in a joining die, and this has an adverse effect on the relative orientation of the separator plates 2a, 2b with respect to one another.

In FIG. 3A, the separator plates 2a, 2b of each bipolar plate are positioned correctly with respect to one another. Adjacent bipolar plates 2, however, are laterally misaligned with respect to one another, resulting in a misalignment between the channel structures 29. Possible consequences of this lateral misalignment are losses of performance or damage to the components, in particular thermal damage. Furthermore, in FIG. 3B it can be seen that the separator plates 2a, 2b therein are not positioned correctly with respect to one another. In particular, it is clear in FIG. 3B that end faces 27a, 27b of the separator plates 2a, 2b are out of alignment with one another. This makes welding the separator plates 2a, 2b difficult in the joining step. In addition, the coolant no longer flows through defined channels 19, so with this arrangement only insufficient cooling would take place.

The present disclosure was devised in order to enable considerably more precise orientation or positioning of the separator plates 2a, 2b relative to one another or in a die. FIG. 3C shows an arrangement of bipolar plates 2 or separator plates 2a, 2b according to an embodiment of the present disclosure which is distinguished by a very small misalignment between the bipolar plates 2 or separator plates 2a, 2b. In the detail shown in FIG. 3C, the two metal sheets 2a, 2b are optimally positioned on top of one another. As a result, firstly the end faces 27a, 27b thereof have as large a contact surface as possible, enabling a particularly simple and long-lasting weld. Secondly, this creates the ideal shape for the cooling channels 19 and thus leads to optimal cooling. The bipolar plates or separator plates of FIG. 3 are precisely oriented or positioned by means of positioning openings 40, 40a, 40b, 50, which are explained in more detail below.

FIG. 4 is a plan view of a bipolar plate 200, the viewing direction being in the negative z-direction 7. The bipolar plate 200 according to FIG. 4 can have all the features of the separator plates 2a, 2b according to FIGS. 1 and 2. In the process, recurring features are denoted by the same reference signs, as before. Like the separator plates 2a, 2b according to FIGS. 1 and 2, the bipolar plate 200 according to FIG. 4 thus comprises two separator plates or metal sheets 2a, 2b. The separator plates or metal sheets 2a, 2b are in contact with one another along their mutually facing planar faces and are interconnected along their mutually facing planar faces. Preferably, the metal sheets 2a, 2b of the bipolar plate 200 are integrally bonded together, preferably by one or more welds, e.g. by one or more laser welds. In the process, the connection is produced not only along the edges, but also in the region of the electrochemically active region 18, the latter in particular for reducing the transfer resistance. Alternatively, solder or adhesive connections are also possible. Like the bipolar plates 2 according to FIGS. 1 and 2, the bipolar plate 200 according to FIG. 4 can have through-openings 11a-c, bead arrangements 12a-d, an electrochemically active region 18, at least one distribution or collection region 20, a transition region 21 arranged between each of the regions 18 and 20, and an outer-edge region 22.

It should be noted here that instead of the bead arrangements 12a-d, self-contained recesses molded into the plate material, and elastomeric sealing lips arranged therein, can also be provided. The shape of these recesses and sealing lips can be the same as the shape of the bead arrangements 12a-d that is shown in the figures. In the following, the bead arrangements 12a-12d and the recesses/sealing lips are generally referred to as self-contained sealing elements.

The bipolar plate 200 according to FIG. 4 differs from the bipolar plates 2 according to FIGS. 1 and 2 in that the bipolar plate 200 according to FIG. 4 has two positioning openings 40a and 40b.

In the embodiment of the bipolar plate 200 according to FIG. 4, the two positioning openings 40a, 40b are arranged in two diagonally opposed corner regions of the substantially rectangular bipolar plate 200. It goes without saying that in alternative embodiments the positioning openings can also be arranged in other regions of the outer-edge region 22 of the bipolar plate 200 or of the separator plates 2a, 2b. In alternative embodiments, the bipolar plate 200 can of course also have more than two positioning openings, e.g. three, four or more than four. It can also be seen in FIG. 4 that the positioning openings 40a, 40b are arranged outside the flow field 17 and the regions 18, 20, 21 and outside the closed bead arrangements 12a-12d, and are spaced apart therefrom. Whereas the positioning opening 40a is round, the positioning opening 40b is slot-shaped. The positioning openings 40a, 40b have a maximum diameter or a maximum extension dₘₐₓ that is smaller than the maximum diameter of the media-conducting through-openings 11a-c.

The positioning opening 40a or 40b of the bipolar plate 200 is formed by overlapping or aligned positioning openings 40, 50 of the separator plates 2b, 2a. The function of the positioning openings 40a, 40b, 40, 50 is to position the particular separator plate 2b, 2a relative to a die, to a further, directly adjoining separator plate or to a further, indirectly adjoining bipolar plate. In the relevant regions, the edge reinforcements of the MEAs (not shown here) have passageways such that, by means of positioning pins, MEAs (in particular together with GDLs) can be built up to form a stack alternating with bipolar plates. The positioning openings 40a, 40b, 40, 50 are each configured as through-openings. Normally, however, this kind of through-opening is not associated with any media-conducting function. In particular, the positioning openings 40a, 40b, 40, 50 are functionally and structurally distinct from the fluid-conveying through-openings 11a, 11b, 11c.

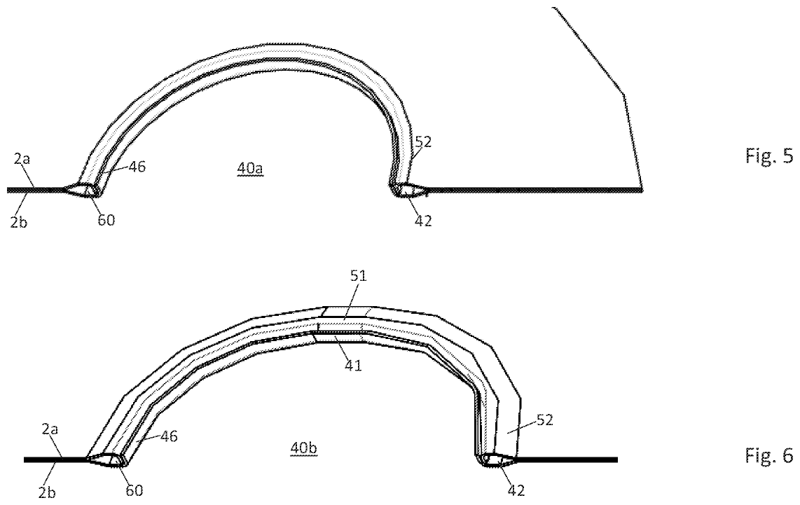

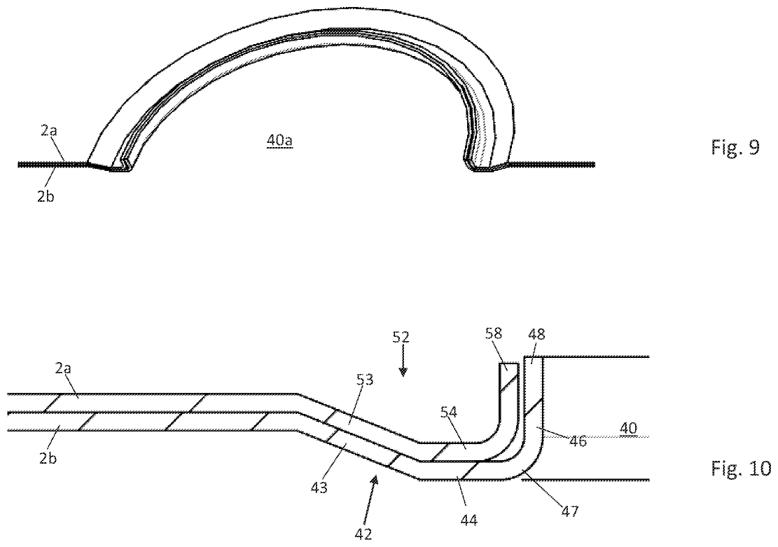

FIG. 5-12 show positioning openings 40a or 40b of the bipolar plate 200 according to various embodiments of the present disclosure.

In this respect, FIG. 5 shows a round positioning opening 40a in each of the two separator plates 2a, 2b, similar to that shown at the bottom left in FIG. 4, whereas FIG. 6 shows a slot-shaped positioning opening 40b in each of the two separator plates 2a, 2b, similar to that shown at the top right in FIG. 4.

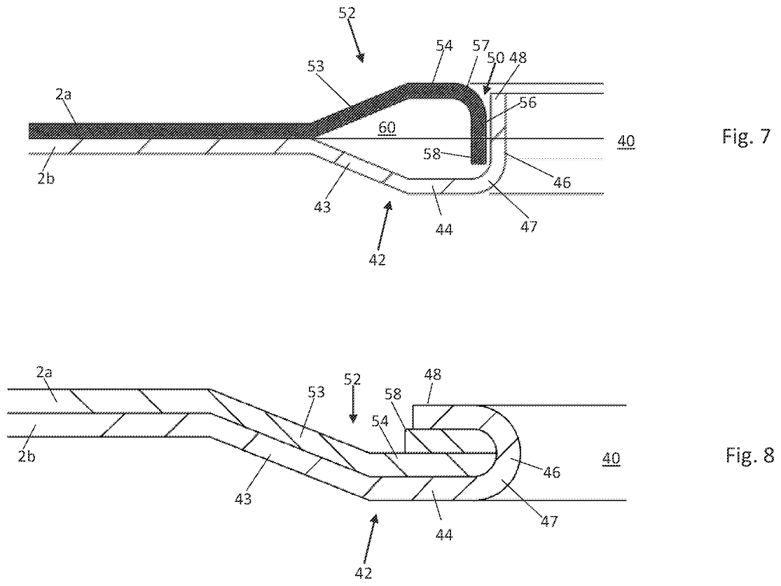

Each separator plate 2a, 2b thus comprises at least one positioning opening 40, 50, with one projection 42, 52 and one collar 46, 56 being provided per positioning opening 40, 50. In the process, the collar 46, 56 adjoins the particular projection 42, 52 and positioning opening 40, 50. The collar 46, 56 can thus be arranged in the radial direction between the positioning opening and the projection 42, 52 (see e.g. FIGS. 7 and 10). The projection 42, 52 and the collar 46, 56 wrap around the particular positioning opening 40, 50. The projection 42, 52 and the collar 46, 56 typically form a stamped structure and are produced together with the positioning opening 40, 50 in one work step (see production method below). The projection 42, 52 forms a circumferential bead which encloses the positioning opening 40, 50. Since the positioning opening 40, 50 has no fluid-conducting function, no sealing function is associated with the bead formed by the projection 42, 52. It can be seen from the figures that the positioning opening 40, 50, the collar 46, 56 and the projection 42, 52 are formed integrally, i.e. in one piece, with the separator plate 2a, 2b, i.e. in or out of the metal sheet of the separator plate 2a, 2b. This means that the collar 46, 56 and the projection 42, 52 are molded-in directly into the separator plate 2a, 2b, in particular into the metal sheet thereof. The positioning opening 40, 50 is likewise molded-in directly into the separator plate 2a, 2b, in particular into the metal sheet thereof.

In this context, the positioning opening 40 of the first separator plate 2b is smaller than the positioning opening 50 of the second separator plate 2a in both the circular embodiment of FIG. 5 and the slot-shaped embodiment of FIG. 6. The second positioning opening 50 thus surrounds the first positioning opening 40. The positioning opening 40a of the bipolar plate is thus substantially formed by the contour of the first positioning opening 40 or by the collar 46.

The elements 40, 42, 43, 44, 46, 47, 48 thus belong to the first separator plate 2b and, hereinafter, are described by the adjective “first”, whereas the elements 50, 52, 53, 54, 56, 57, 58 belong to the second separator plate 2a and are denoted by the adjective “second”.

The first projection 42 typically comprises a first flank portion 43, which rises obliquely from the relevant plate plane, and a first plateau portion 44, which is generally oriented in parallel with the plate plane of the associated separator plate 2b. The first plateau portion 44 of the first projection 42 is normally adjoined by a first curvature region 47 of the first collar 46, said curvature region facing the plate plane. The first collar 46 can also comprise a first end portion 48.

Similarly, the second projection 52 typically comprises a second flank portion 53, which rises obliquely from the plate plane, and a second plateau portion 54, which is generally oriented in parallel with the plate plane of the associated separator plate 2a. The second plateau portion 54 of the second projection 54 is normally adjoined by a second curvature region 57 of the second collar 56, said curvature region facing the plate plane. The second collar 56 can also comprise a second end portion 58.

It can be seen from FIG. 5-12 that the first collar 46 engages in the second collar 56. In particular, the first collar 46 and the second collar 56 form-fittingly mesh with one another at least in some portions. In some embodiments, in particular in the case of circular positioning openings, the collars 46, 56 form a circumferential form fit, whereas in other embodiments, in particular in the case of slot-shaped positioning openings, the collars 46, 56 are in contact with one another in some portions in the circumferential direction. In the case of slot-shaped positioning openings, it is particularly preferable for the portion-wise contacting to occur in portions 41, 51 of the two separator plates that are not curved when looking in a plan view of the plane of the relevant separator plates.

In the embodiment examples of FIGS. 5, 6, 7, 9 and 10, the two collars 46, 56, in particular the end portions 48, 58 thereof, are oriented at an angle, preferably substantially perpendicularly, to the particular plate plane. In addition, the collars 46, 56 or the end portions 48, 58 thereof protrude through the particular plate plane. The arrangement shown in FIG. 8 differs from the arrangement shown in FIG. 10 on account of the radially outwardly curved transitions between collars 46, 56 and end portions 48, 58. As a result, the end portions 48, 58 in the bipolar plate 200 are oriented substantially in parallel with the particular plate plane of the separator plates 2a, 2b.

In some embodiments, the projections 42, 52 and/or collars 46, 56 are annular. The collars 46, 56 and the positioning opening 40, 50 define an axial direction, which is oriented in parallel with the stacking direction (z-direction). Owing to the production of the separator plates (see below), an axial length of the collar 46, 56 may not be constant in the circumferential direction of the collar 46, 56. The axial length of the collar 46, 56 can also be referred to as the height of the collar 46, 56. The height of the first collar 46 is typically larger than the height of the second collar 56.

The axial height of the projection 42, 52 and the height of the collar 46, 56 are selected such that the projection 42, 52 and the collar 46, 56 are not compressed when the electrochemical system 1 is formed by compressing the stacked bipolar plates 200. The shape or dimensions of the projection 42, 52 and of the collar 46, 56 are thus constant, in particular regardless of a state of the separator plates 2b, 2a (compressed/not compressed; installed/not installed; stacked/not stacked).

According to the embodiments of FIG. 5-7, the end portions 48, 58 of the two collars 46, 56 point in opposite directions. In addition, the two projections 42, 52 face away from one another and form a cavity 60. Alternatively, the end portions 48, 58 of the two collars 46, 56 can point in the same direction; see in particular FIGS. 8 to 10. In these embodiments, the two projections 42, 52 can be in contact with one another at least in some portions.

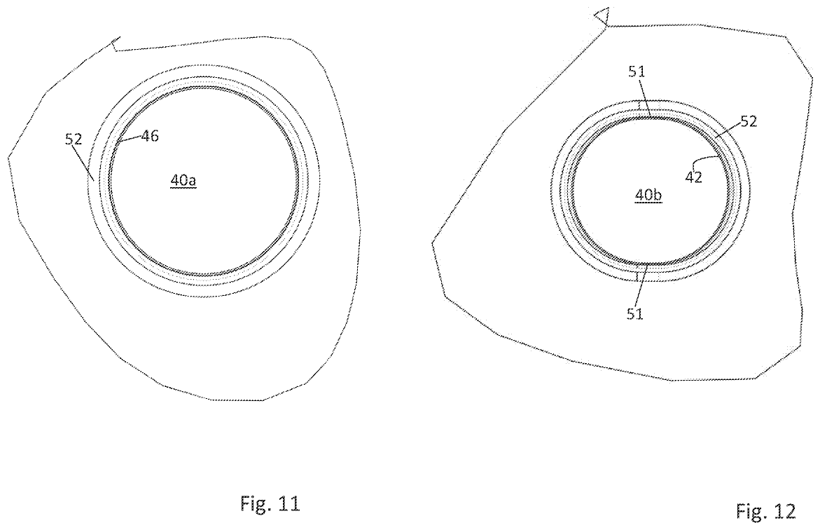

FIGS. 11 and 12 are two plan views of positioning openings 40a, 40b. The positioning opening 40a of FIG. 11 has a circular shape. A distance in the radial direction from a center point of the positioning opening to the collar 46, 56 is thus constant. The positioning opening 40b of FIG. 12 is distinguished on account of being slot-shaped, in which case a radial distance, measured from a center point of the positioning opening 40b, to the collar 46, 56 is not constant. However, the present disclosure is not limited to the shapes of the positioning openings 40a, 40b shown in FIGS. 11 and 12. In alternative embodiments, the positioning opening can, for example, be oval or a rounded polygon.

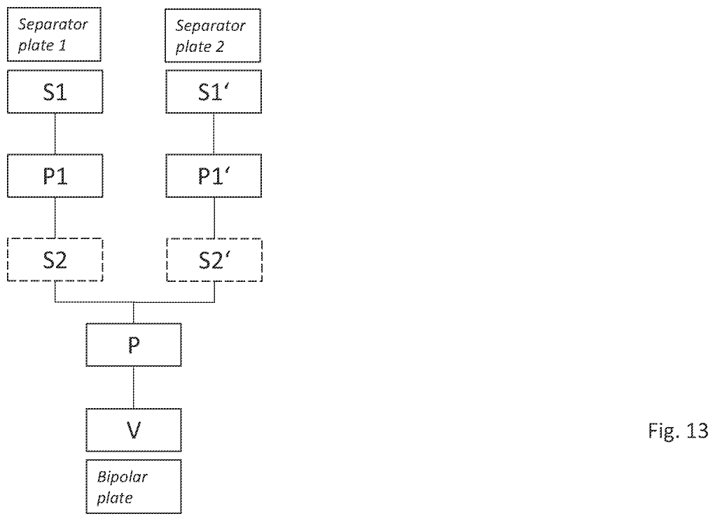

An embodiment of a method for producing the individual plates 2a, 2b and for producing the bipolar plate 200 is described below on the basis of FIG. 13.

In a preparatory step, two plates in the form of metal sheets are provided, namely a first plate and a second plate.

In step S1, at least one position hole is formed in the first plate, the position hole preferably being generated by punching the plate by means of a punching die. In step P1, the first plate is deformed such that, simultaneously, one positioning opening 40 of the above-described type having a first projection 42 and a first collar 46 is formed per position hole, and a flow field 17 of the above-described type is formed for conducting a medium along a planar face of the separator plate 2b.

Preferably, the deformation is carried out by deep-drawing, stamping or hydroforming the plate in a corresponding deep-drawing, stamping or hydroforming die. In the process, the first collar 46 is preferably formed by deforming an edge of the position hole. Consequently, the resultant positioning opening 40 has a larger diameter or a larger area than the original position hole. Due to production tolerances, an arrangement of a center point of the positioning opening 40 may differ from an initial arrangement of a center point of the position hole. In a subsequent step S2, an outer contour of the separator plate 2b is formed by cutting the metal sheet to size. Step S2 is carried out, for example, by means of a cutting device, such as a punching device or a laser-cutting device. The first separator plate 2b is now complete. Alternatively, the outer trimming can also be carried out at the same time as step S1, in which case step S2 is omitted.

The second separator plate 2a is produced at the same time as or before the formation of the first separator plate 2b.

In step S1′, at least one position hole is formed in the second plate, the position hole preferably being generated by punching the second plate. In step P1′, the second plate is deformed such that, simultaneously, one positioning opening 50 of the above-described type having a second projection 52 and a second collar 56 is formed per position hole, and a flow field 17 is formed for conducting a medium along a planar face of the separator plate 2a.

Preferably, the deformation is carried out by deep-drawing, stamping or hydroforming the second plate in a corresponding deep-drawing, stamping or hydroforming die. In the process, the second collar 56 is preferably formed by deforming an edge of the position hole. The resultant positioning opening 50 thus has a larger diameter or a larger area than the original position hole. Due to production tolerances, an arrangement of a center point of the positioning opening 50 may differ from an initial arrangement of a center point of the position hole. In a subsequent step S2′, an outer contour of the second separator plate 2a is formed by cutting the metal sheet. Step S2′ is carried out, for example, in a cutting device, such as a punching device or a laser-cutting device. The second separator plate 2a is now complete. In this case, too, step S2′ can be omitted if the trimming of the outer contour is already carried out in step S1′.

By simultaneously forming the positioning opening 40, 50, the collar 46, 56, the projection 42, 52 and the media-conveying stamped structures 17, 18, 20, 21 in the same die, production tolerances can firstly remain constant, and second be adhered to more effectively. Since the positioning openings 40, 50 and the particular flow field 17 are simultaneously molded into the plate, the positioning opening 40, 50 and the flow field 17 of the particular separator plate 2b, 2a can be arranged very precisely with respect to one another. By way of example, the positioning opening 40, 50 and the flow field 17 can be at a predetermined position and/or orientation with respect to one another, a divergence from the predetermined position being less than 200 μm, preferably less than 100 μm, in particular less than 50 μm. In addition, the precision of the production of the positioning opening depends substantially on just one die, namely the hydroforming, stamping or deep-drawing die. The arrangement of the position hole formed beforehand by the punching die can have a greater production tolerance. The final arrangement of the center point of the positioning opening 40, 50 can thus differ from the initial arrangement of the center point of the position hole. In this case, the axial length of the collar 46, 56 is not constant in the circumferential direction of the collar 46, 56. The free end of the collar 46, 56 on the end portion 48, 58 thus spans a slanted plane that is not parallel to the plate plane and which encloses an angle therewith.

Once the two separator plates 2a, 2b have been completed, the separator plates 2a, 2b are placed on top of one another such that the first collar 46 engages in the second collar 56. For example, the separator plates 2a, 2b can be placed on top of one another by means of a centering pin of a fixing device, the centering pin engaging in the positioning openings 40, 50. In the positioning step P, the separator plates 2a, 2b are joined together to form the bipolar plate 200. The separator plates 2a, 2b are form-fittingly fixed in place at least in some portions by the first collar 46 engaging in the second collar 56. As a result, further measures for fixing the two separator plates 2a, 2b in place relative to one another can be omitted.

To produce the embodiment of the bipolar plate 200 shown in FIG. 8, the embodiment shown in FIG. 10 is produced first. In a subsequent step, the collars 46, 56 are bent radially outwards, for example by flanging the collar 46. As a result, the separator plates 2a, 2b can be fixed in place relative to one another.

Once positioned, the separator plates 2a, 2b can be integrally bonded together in connection step V, preferably by welding, in particular laser welding, soldering or gluing.

The electrochemical system 1 is then formed by stacking and subsequently compressing the bipolar plates 200 and the MEAS 10. When the bipolar plates 200 are compressed, the shape of the projections 42, 52, of the collars 46, 56 and of the position openings 40, 50 is retained since these are not compressed. To position the bipolar plates 200 relative to one another, the positioning holes 40a, 40b can be used in conjunction with centering pins of a positioning die. By means of the positioning holes 40a, 40b, the bipolar plates 200 can be positioned relative to one another and oriented and stacked with a high degree of precision.

It goes without saying that features of the above-described embodiments can be claimed either in combination with one another or individually unless they contradict one another.

### LIST OF REFERENCE SIGNS

1 electrochemical system
2 Bipolar plate
2a Individual plate
2b Individual plate
3 End plate
4 end plate
5 Media port
6 Stack
7 Z-direction
8 x-direction
9 Y-direction
10 Membrane electrode unit
11a-c Through-openings
12a-c Sealing beads
13a-c Passages
14 Membrane
15 Edge portion
16 Gas diffusion layer
17 Flow field
18 Electrochemically active region
19 Cavity
20 Distribution and collection region
21 Transition region
22 Outer-edge region
24 Contact region
27a, b End faces
29 Channel
40 First positioning opening
40a Positioning opening
40b Positioning opening
41 Non-curved portion
42 First projection
43 First flank portion
44 First plateau portion
46 First collar
47 First curvature region
48 First end portion
50 Second positioning opening
51 Non-curved portion
52 Second projection
53 Second flank portion
54 Second plateau portion
56 Second collar
57 Second curvature region
58 Second end portion
60 Cavity
200 Separator plate

1. A separator plate for an electrochemical system, comprising
a flow field for conducting a medium along a planar face of the separator plate,
at least one positioning opening and
one projection and one collar per positioning opening,
wherein the projection and the collar wrap around the positioning opening, and wherein the collar adjoins the positioning opening and the projection.

2. The separator plate according to claim 1, wherein the separator plate defines a plate plane, and the collar is oriented substantially perpendicularly to the plate plane.

3. The separator plate according to claim 2, wherein the collar protrudes through the plate plane.

4. The separator plate according to claim 2, wherein the collar has a curvature region facing the plate plane.

5. The separator plate according to claim 1, wherein one or more of the positioning opening, the collar, and the projection are formed integrally with the separator plate.

6. The separator plate according to claim 1, wherein one or more of the collar and the positioning opening define an axial direction, and wherein an axial length of the collar is not constant in the circumferential direction of the collar.

7. The separator plate according to claim 1, wherein the positioning opening and the flow field are at a predetermined position with respect to each other, a predetermined orientation with respect to one another, or both, and wherein a divergence from the predetermined position is less than 200 μm.

8. The separator plate according to claim 1, wherein a distance, measured in the radial direction, from a center point of the positioning opening to the collar is constant.

9. The separator plate according to claim 1, wherein the positioning opening is configured to be circular, oval, slot-shaped or a rounded polygon.

10. A bipolar plate comprising a first separator plate and a second separator plate,
wherein the first separator plate has a first positioning opening having a first projection and a first collar, and the second separator plate has a second positioning opening having a second projection and a second collar,
wherein the first positioning opening is smaller than the second positioning opening and the first collar engages the second collar, and
wherein the two separator plates are joined together.

11. The bipolar plate according to claim 10, wherein the first collar and the second collar form-fittingly mesh with one another at least in some portions.

12. The bipolar plate according to claim 10, wherein the collar and the position openings define an axial direction, and wherein the second collar has a shorter axial length than the first collar.

13. The bipolar plate according to claim 10, wherein end portions of the two collars point in opposite directions, and wherein the two projections face away from one another and form a cavity.

14. The bipolar plate according to claim 10, wherein end portions of the two collars point in the same direction, and wherein the two projections are in contact with one another at least in some portions.

15. A method for producing a separator plate, comprising the steps of:
providing a plate,
forming at least one position hole in the plate,
deforming the plate such that, simultaneously,
one positioning opening having one projection and one collar is formed per position hole, and
a flow field is formed for conducting a medium along a planar face of the separator plate,
wherein the projection and the collar surround the positioning opening, and wherein the collar adjoins the positioning opening and the projection.

16. The method according to claim 15, wherein the collar is formed by deforming an edge of the position hole.

17. The method according to claim 15, wherein the deformation of the plate involves at least one of: deep-drawing the plate; stamping the plate; and hydroforming the plate.

18. A method for producing a bipolar plate which has a first separator plate and a second separator plate, comprising the steps of:
producing the first separator plate having at least a first collar and a first positioning opening,
producing the second separator plate having at least a second collar and a second positioning opening,
wherein the first positioning opening is smaller than the second positioning opening,
positioning the separator plates on top of one another such that the first collar engages the second collar, and
connecting the two separator plates.

19. The method according to claim 18, wherein the separator plates are operable to be form-fittingly fixed in place at least in some portions by the first collar engaging in the second collar.

20. The method according to claim 18, wherein, in the connection step, the separator plates are materially bonded together.
